(19) United States
(12) Patent Application Publication
(10) Pub. No.: US 2026/0233848 A1
(43) Pub. Date: Aug. 13, 2026

(54) SPEED CONTROL METHOD AND CONTROL DEVICE

(71) Applicant: SAFRAN, Paris (FR)

(72) Inventors: Damien Jacques Arthur BONHOMME, Moissy-Cramayel (FR); Ana TRUC-HERMEL, Moissy-Cramayel (FR); Guillaume François Daniel BIDAN, Moissy-Cramayel (FR)

(73) Assignee: SAFRAN, Paris (FR)

(21) Appl. No.: 19/149,341

(22) PCT Filed: Jan. 17, 2024
(86) PCT No.: PCT/FR2024/050064

§ 371 Date: Jul. 18, 2025

(30) Foreign Application Priority Data
Jan. 18, 2023 (FR) 2300473

(51) Int. Cl. B64D 31/18; B64D 27/33; B64D 27/357

(52) U.S. Cl. CPC B64D 31/18; B60L 50/60; B60L 58/12; B60W 20/00; B64D 27/33; B64D 27/357; F01D 15/10; F02C 9/00

(57) ABSTRACT

A method for controlling the speed of an engine assembly of an aircraft, including updating the speed setpoint of the engine assembly as a function of the current state-of-charge of an onboard energy storage device, and controlling the engine assembly according to the speed setpoint of the engine assembly, as well as a control device suitable for implementing this method and an engine assembly and an aircraft incorporating such a control device.

### TECHNICAL FIELD

The present invention relates to the technical field of the control of aircraft motor assemblies, and more particularly to aircraft motor assemblies comprising at least one electric machine and a combustion engine, in particular a gas turbine engine.

### PRIOR ART

In order to increase the overall energy efficiency of transport means, and to reduce their fuel consumption and greenhouse gas emissions, increasing electrification of engine assemblies is being considered. In the aviation field, there is in particular a trend towards extracting increasing power through electric machines incorporated into engine assemblies, in particular to replace pressurised air extraction for auxiliary devices. In addition, there are many hybrid engine assemblies in which these electric machines are used not only to extract power, but also to introduce it into the engine assembly in order to provide assistance beyond simple start-up. Although these hybrid engine assemblies have most often been proposed for automotive vehicles and incorporate piston engines, hybridisation of aircraft engine assemblies and more particularly engine assemblies incorporating one or more gas turbine engines has also been considered.

Hybridisation of aircraft engine assemblies requires the incorporation in the aircraft of on-board energy storage devices to supply the power to be introduced into the engine assembly via the electric machine. These on-board energy storage devices can take the form, in particular, of rechargeable electric batteries, although other energy storage devices, such as supercapacitors or flywheels for example, are also possible. In order to recharge these on-board energy storage devices, hybridisation will normally further increase the amount of electrical power extracted from the engine assembly during operating phases that do not require electrical assistance, in particular at idle outputs.

During idle phases on the ground and in flight, it is normally desirable to minimise thrust and therefore the output of the engine assembly. However, this output is normally constrained by the operability stops of the engine assembly and by the requirement for an ability for respond to transient fluctuations in the power extraction, both in the context of a sudden decrease (load release) and in the context of a sudden increase, due for example to a short-circuit. The ability of combustion engines, and in particular gas turbine engines, to absorb these sudden fluctuations increases with engine output. However, their fuel consumption then also increases.

In European patent application EP 3 845 750 A1, an engine assembly was proposed incorporating a gas turbine engine with two rotating shafts, as well as an electric machine coupled to each of the rotating shafts, and a method of distributing power extraction between these rotating shafts as a function of the engine output.

In French patent application FR 3 097 012 A1, it was proposed to use hybridisation of the engine assembly to improve its response to load fluctuations, in particular at idle outputs.

In international patent application WO 2021/018524 A1, it is proposed to use an on-board energy storage device to help reduce transient fluctuations in power extraction on an aircraft engine assembly.

However, the ability of an on-board energy storage device to reduce transient fluctuations in power extraction from an aircraft engine assembly will normally depend on its state of charge.

### DISCLOSURE OF THE INVENTION

The objective of the present disclosure is to provide an output regulation method and a control device for an aircraft engine assembly that can handle any transient fluctuations in power extraction while minimising energy consumption and taking into account the availability of an on-board energy storage device.

For this purpose, according to a first aspect of this disclosure, this method may comprise at least steps for updating an output setpoint of the engine assembly as a function of a current state of charge of an on-board energy storage device, and for controlling the engine assembly according to the output setpoint of the engine assembly. In particular, the output of the engine assembly can remain an idle output lower than a maximum nominal output of the engine assembly, in particular less than or equal to 70% of said maximum nominal output. The output of the engine assembly can be taken to mean the speed of rotation of a shaft of the engine assembly. However, other definitions of engine assembly output are also possible: for example, engine assembly output can alternatively be defined in terms of thrust.

According to a second aspect, the updating of the output setpoint may comprise steps for determining a difference in the state of charge of an on-board energy storage device, and comparing said state-of-charge difference with a difference threshold. The engine output setpoint can then be updated according to a result of the comparison of said difference with said difference threshold.

The engine output setpoint can then be updated according to the result of the comparison of said difference with said difference threshold, so as to take account of this difference and the current state of charge in the control of the engine output in order to optimise an output of the engine assembly, in particular an idling output, to respond to fluctuations in extraction by minimising its energy consumption at all states of charge of the on-board energy storage device.

According to a third aspect, a maximum electrical power that can be extracted from the engine assembly at an output of the engine assembly according to the output setpoint may be less than an electrical power required by the aircraft, said difference threshold may be a discharge threshold, and said reference state of charge may be a state of charge of the on-board energy storage device when the maximum electrical power that can be extracted from the engine assembly has become less than the electrical power required by the aircraft. In particular, in the step of updating the engine assembly output setpoint, the output setpoint can then be maintained at a previous level if said state-of-charge difference does not exceed the discharge threshold, electric assistance is required for the engine assembly, and/or an upper threshold of the output of the engine assembly is reached, and can be increased if said difference in the state of charge exceeds the discharge threshold, the electrical assistance is not required for the engine assembly, and the upper threshold of the output of the engine assembly is not reached. The discharge threshold can be assigned a first value when the current state of charge is not less than an upper state-of-charge threshold, and can be assigned a second value, different from the first value, when the current state of charge is less than the upper state-of-charge threshold, but not less than a lower state-of-charge threshold.

Thus, as long as a maximum electrical power that can be extracted from the engine assembly at said engine assembly output is less than an electrical power required by the aircraft, and this deficit must therefore be made up by extracting power from the on-board energy storage device and/or by increasing the output of the engine assembly and therefore the maximum electrical power that can be extracted from it, the progressive discharge of this on-board energy storage device can trigger an increase in output when it exceeds the discharge threshold, which can itself vary as a function of the current state of charge in order to indirectly also take its absolute value into account.

According to a fourth aspect, a maximum electrical power that can be extracted from the engine assembly at an engine assembly output according to the output setpoint may not be less than an electrical power required by the aircraft, said difference threshold may be a charge threshold, and said reference state of charge may then be a state of charge of the on-board energy storage device when the maximum electrical power that can be extracted from the engine assembly has become greater than or equal to the electrical power required by the aircraft, or the engine assembly output setpoint has been reduced. The engine output setpoint can then be maintained if the difference in the state of charge does not exceed the charge threshold and/or the engine output setpoint is at a lower threshold. The charge threshold can be assigned a first value when the state of charge is not less than an upper state-of-charge threshold, and assigned a second value, different from the second value, when the state of charge is less than the upper state-of-charge threshold, but not less than a lower state-of-charge threshold.

Thus, while a maximum electrical power that can be extracted from the engine assembly at said engine assembly output is greater than or equal to an electrical power required by the aircraft, the output setpoint can be maintained so long as this surplus can be used to recharge the on-board energy storage device without exceeding the charge threshold, which can itself vary as a function of the state of charge so as to indirectly also take account of its absolute value.

A fifth aspect relates to a control device configured to implement the method according to any of the preceding aspects.

A sixth aspect relates to an aircraft engine assembly comprising a control device according to the fourth aspect, a combustion engine, and an electric machine configured to extract electrical power. The electric machine can also be configured to provide electrical assistance to the engine assembly. The combustion engine may be a gas turbine engine.

A seventh aspect concerns an aircraft comprising an engine assembly according to the fifth aspect, as well as an on-board energy storage device electrically connected to said electric machine of the engine assembly.

### BRIEF DESCRIPTION OF THE DRAWINGS

FIG. 1 is a schematic representation of the electrical and control networks of an aircraft.

FIG. 2 is a flow chart of a method for controlling the output of an engine assembly of the aircraft of FIG. 1.

FIG. 3 is a flowchart of a subroutine of the method in FIG. 2, followed when a maximum electrical power that can be extracted from the engine assembly is less than an electrical power required by the aircraft.

FIG. 4 is a flow diagram of a mode of implementation of a output setpoint reduction step in the subroutine of FIG. 3.

FIG. 5 is a flowchart of a subroutine of the process of FIG. 2, followed when the maximum electrical power that can be extracted from the engine assembly at said engine assembly output is greater than or equal to an electrical power requirement of the aircraft.

### DESCRIPTION OF THE EMBODIMENTS

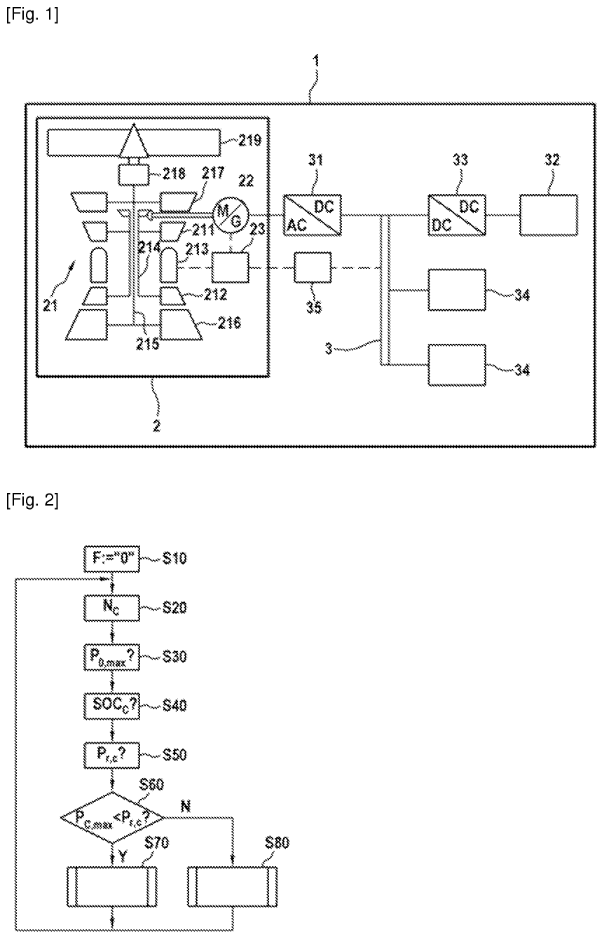

As illustrated in FIG. 1, an aircraft 1 may comprise one or more engine assemblies 2, each of which may include at least one combustion engine 21, in particular in the form of a gas turbine engine, comprising at least one compressor 211, a turbine 212, a combustion chamber 213 disposed in a stream of air between the compressor 211 and the turbine 212, and a rotary shaft 214 mechanically connecting the compressor 211 and the turbine 212. In particular, as illustrated, such a gas turbine engine may be a turbofan engine, comprising at least one other rotary shaft 215 concentric with the rotary shaft 214 and mechanically connecting another turbine 216 downstream of the turbine 212 to another compressor 217 upstream of the compressor 211, as well as, possibly through a reducer 218, to a fan 219, which may be ducted or unducted. However, the present disclosure is not limited to turbofan engines or even to gas turbine engines, being equally applicable to other types of gas turbine engines, such as turboprops or turboshaft engines, or even to other types of combustion engines, such as piston engines.

As also illustrated in FIG. 1, each engine assembly 2 may also comprise an electric machine 22 coupled to a rotary shaft of the combustion engine, such as the rotary shaft 214 for example. This electric machine 22 may in particular be a generator configured to extract electrical power from the engine assembly 2, although it may in particular be, as illustrated, a motor/generator that can alternatively provide electrical assistance to the engine assembly 2. This electric machine 22 may be electrically connected to an electrical network 3 of the aircraft 1, for example via a converter 31, which may in particular be an AC/DC converter as illustrated. The aircraft 1 may also comprise one or more on-board energy storage devices 32, each also connected to the electrical network 3, for example via a converter 33, which may in particular be a DC/DC converter as illustrated. These on-board energy storage devices 32 may in particular take the form of rechargeable batteries configured to store energy electrochemically. However, other types of on-board energy storage devices are also possible, as an alternative to or in combination with rechargeable batteries, such as flywheels or supercapacitors. In addition, the aircraft 1 may also comprise one or more electrical loads 34 also connected to the electrical network 3.

As also illustrated in FIG. 1, each engine assembly 2 may also include a control device 23 connected to the combustion engine 21 and to the electric machine 22 in order to regulate the output of the engine assembly 2. This control device 23 can, in particular, take the form of an electronic control unit. The control device 23 can be connected to the combustion engine 21 to control, for example, its fuel supply and/or the position of variable geometry elements of the combustion engine 21, such as blades, vanes, discharge valves and/or the nozzle. In addition, the control device 23 can be connected to the electric machine 22 to control the electrical power extracted from or injected into the engine assembly 2 through the electric machine 22. In addition, the aircraft may comprise at least one other control device 35, which can be connected to the control device 23, the converters 31, 33, the on-board energy storage devices 32, and/or the electrical loads 34, in order to control energy transfers through the electrical network 3. This other control device 35 may also take the form of an electronic control unit. Furthermore, although the control devices 23, 35 are presented here as two separate devices, it would also be possible to combine them into a single device, and in particular into a single electronic control unit.

The control device 23 can be adapted to implement a process for controlling the output of the engine assembly 2, in particular for lower outputs, both in flight and on the ground.

Thus, as illustrated in FIG. 2, this control method may comprise a step S10 of initialising a flag F to assign it a zero value. This step S10 may be followed by a recurrent loop comprising a step S20 of controlling the engine assembly 2 according to an output setpoint Nc of the engine assembly 2, followed by a step S30 of determining a maximum electrical power Po, max that can be extracted from the engine assembly 2 at the output of the engine assembly according to said output setpoint N_{c}, as well as a step S40 of determining a current state of charge SOC_{c} of the on-board energy storage devices 32 and a step S50 of determining a current electrical power P_{r,c} required by the aircraft 1. Although steps S40 and S50 are shown in FIG. 2 as following steps S20 and S30, they could also be carried out simultaneously with these. Steps S20, S40 and S50 may be carried out using respective sensors (not shown) arranged on the engine assembly 2 and the electrical network 3, while step S30 may, for example, be carried out using a mathematical formula and/or a correspondence table stored in and applied by the control device 23. In addition, filters, such as a low-pass or moving average filter, can be applied in these steps to avoid too sudden or frequent changes in the output setpoint N_{c} as a result of fluctuations in the powers P_{o,max} or P_{r,c}.

In a subsequent step S60 of the illustrated control method, the maximum electrical power P_{o,max} that can be extracted from the engine assembly 2 is compared with the current electrical power P_{r,c} required by the aircraft 1. If the maximum electrical power P_{o,max} is less than the current electrical power P_{r,c} required by the aircraft 1, a first subroutine S70 for updating the output setpoint N_{c} can be performed. If the maximum electrical power P_{o,max} is greater than or equal to the current electrical power P_{r,c} required by the aircraft 1, a second subroutine S80 for updating the output setpoint N_{c} can be performed.

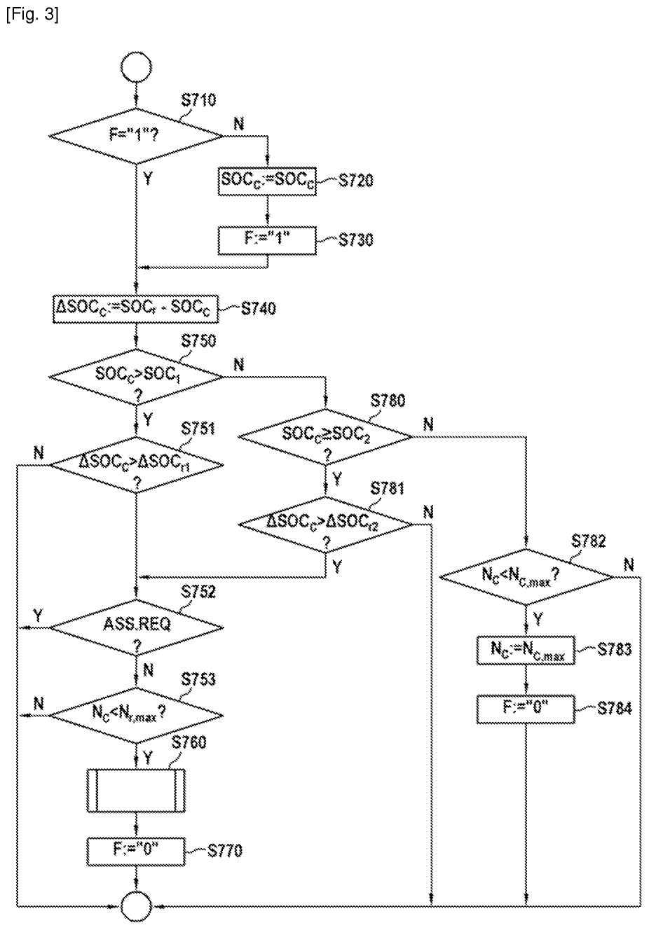

As illustrated in FIG. 3, the first subroutine S70 may comprise a first step S710 of checking the value of flag F. If the value of flag F is different from “1”, indicating that the maximum electrical power P_{o,max} was not less than the current electrical power P_{r,c} required by aircraft 1 or the output setpoint N_{c} was increased in an immediately preceding cycle, the value of the current state of charge SOC_{c} can be assigned to a reference state of charge SOCᵣ and the value “1” assigned to the flag “F” in successive or simultaneous steps S720, S730, before proceeding to a following step S740 in which a state-of-charge difference ΔSOC between the reference state of charge SOCᵣ and the current state of charge SOC_{c} is calculated according to the formula ΔSOC=SOCᵣ−SOC_{c}. If the value of flag F is already “1”, i.e., if in the immediately preceding cycle the maximum electrical power P_{o,max} Was already less than the current electrical power P_{r,c} required by the aircraft 1 and the output setpoint N_{c} has not increased, it is possible to proceed to step S740 for calculating the state-of-charge difference ΔSOC without performing steps S720, S730 for assigning the value of the current state of charge SOC_{c} to the reference state of charge SOCᵣ and the value “1” to the flag F.

Then, in a step S750, the current state of charge SOC_{c} may be compared to an upper state-of-charge threshold SOC₁. If the current state of charge SOC_{c} is greater than the upper state-of-charge threshold SOC₁, subsequent steps S751, S752 and S753 may proceed, respectively, to comparing the state-of-charge difference ΔSOC with a difference threshold which may in particular be a first discharge threshold ΔSOC_{d1}, checking that electric assistance is not required for the engine assembly, and checking that the output setpoint N_{c} has not reached an upper threshold N_{r,max}. Although these steps S751 to S753 are illustrated as being carried out in a certain order, they could be carried out in a different order, or even simultaneously. If the state-of-charge difference ΔSOC does not exceed the difference threshold, electric assistance is required or the output setpoint N_{c} has already reached the upper threshold N_{r,max}, subroutine S70 can be finalised without changing the output setpoint N_{c}. On the other hand, if the state-of-charge difference ΔSOC exceeds the difference threshold, electric assistance is not required, and the output setpoint N_{c} has not reached the upper threshold N_{r,max}, the output setpoint N_{c} may be increased in a step S760, and the value of the flag F may be reset to zero in a step S770 in order to trigger a reference state of charge update SOCᵣ in the following cycle.

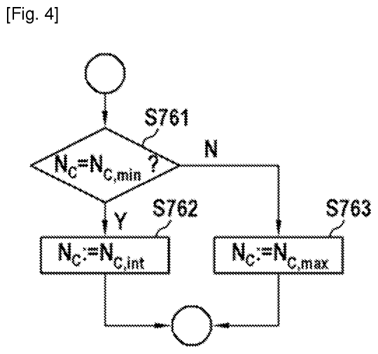

When this control process is specifically directed at controlling an idle output of the engine assembly 2, the value of this output setpoint N_{c} may take a discrete number of levels, such as for example three values including the upper threshold N_{r,max}, which may be for example between 50 and 70% of a maximum nominal output Nₘₐₓ, a lower threshold N_{r,min}, which may be for example between 40 and 60% of a maximum nominal output Nₘₐₓ, and an intermediate level N_{r,int}, located between the maximum N_{r,max} and minimum N_{r,min} thresholds and which may therefore be, for example, between 45 and 65% of the maximum nominal output Nₘₐₓ. In this case, step S760 of increasing the output setpoint N_{c} may take the form illustrated in FIG. 4, comprising a first sub-step S761 in which it is checked whether the output setpoint N_{c} is at the lower threshold N_{r,min}. If the output setpoint N_{c} is at the lower threshold N_{r,min}, it is increased to the intermediate level N_{r,int} in the next sub-step S762. If this is not the case, and the output setpoint N_{c} is therefore already at the intermediate level N_{r,int}, it is increased to the maximum level N_{r,max} in the alternative sub-step S763. However, it is also possible for the output N_{c} to be regulated following a continuous curve, rather than in discrete steps.

If in step S750 the current state of charge SOC_{c} has been found to be less than or equal to the first state-of-charge threshold SOC₁, the subroutine S70 may proceed to step S780, in which the current state of charge SOC_{c} is compared to a second state-of-charge threshold SOC₂ lower than the first state-of-charge threshold SOC₁. If the current state of charge SOC_{c} remains greater than or equal to this second state-of-charge threshold SOC₂, subsequent steps S781, S752 and S753 may, respectively, proceed to compare the state-of-charge difference ΔSOC with a difference threshold which may in particular be a second discharge threshold ΔSOC_{d2} different from the first discharge threshold ΔSOC_{d1}, checking that electric assistance is not required for the engine assembly, and checking that the output setpoint N_{c} has not reached an upper threshold N_{r,max}. If the state-of-charge difference ΔSOC is greater than or equal to the difference threshold, but electric assistance is required or the output setpoint N_{c} has already reached the upper threshold N_{r,max}, subroutine S70 can be finalised without changing the setpoint for the current output N_{c}. If the state-of-charge difference ΔSOC is greater than or equal to this difference threshold, the electric assistance is not required, and the output setpoint N_{c} has not reached the upper threshold N_{r,max}, the output setpoint N_{c} can be increased in step S760, and the value of flag F reset to zero in step S770 to trigger the reference state of charge update SOCᵣ in the following cycle. If the state-of-charge difference ΔSOC does not reach this difference threshold, the output setpoint No can still be compared with the upper threshold N_{r,max} in a step S782. If this maximum level N_{r,max} is reached, subroutine S70 can be finalised directly, but if this upper threshold N_{r,max} is not yet reached, it is possible to adopt its value as the output setpoint N_{c} in a step S783, and reset to zero the value of flag F in a step S784 before finalising subroutine S70 in order to trigger the reference charge state update SOCᵣ in the following cycle.

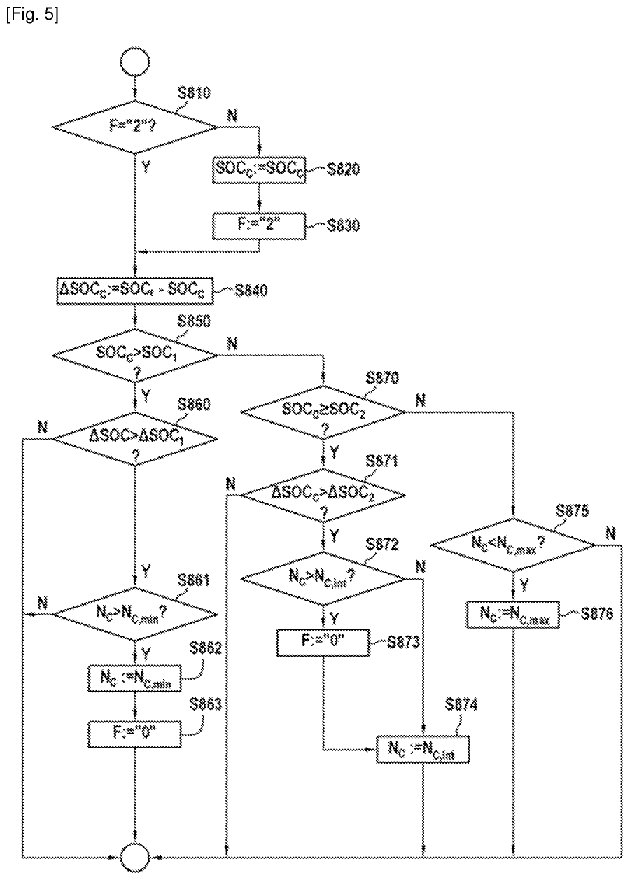

As illustrated in FIG. 5, the second subroutine S80, which may be performed in the event that the maximum electrical power P_{o,max} is greater than or equal to the current electrical power P_{r,c} required by the aircraft 1, may comprise a first step S810 of checking the value of flag F. If the value of flag F is different from “2”, indicating that the maximum electrical power P_{o,max} is still less than the current electrical power P_{r,c} required by aircraft 1 or that the output setpoint N_{c} was decreased in an immediately preceding cycle, the value of the current state of charge SOC_{c} may be assigned to the reference state of charge SOCᵣ and the value “2” assigned to flag “F” in following or simultaneous steps S820, S830, before proceeding to a next step S840 in which a state-of-charge difference ΔSOC between the reference state of charge SOCᵣ and the current state of charge SOC_{c} is calculated according to the formula ΔSOC=SOCᵣ−SOC_{c}. If the value of flag F is already “2”, i.e. if in the immediately preceding cycle the maximum electrical power P_{o,max} was already less than the current electrical power P_{r,c} required by the aircraft 1 and the output setpoint No has not decreased, it is possible to proceed to step S840 for calculating the state-of-charge difference ΔSOC without performing steps S820, S830 for assigning the value of the current state of charge SOC_{c} to the reference state of charge SOCᵣ and the value “2” to the flag F.

Then, in a step S850, the current state of charge SOC_{c} may be compared to a first state-of-charge threshold SOC₁. If the current state of charge SOC_{c} is greater than the first state-of-charge threshold SOC₁, it is possible to proceed in steps S860, S861 to respectively comparing the state-of-charge difference ΔSOC with a difference threshold which may, in particular, be a first state-of-charge threshold ΔSOC_{c1}, and checking that the output setpoint N_{c} is still greater than a lower threshold N_{r,min}. Although these steps S860 and S861 are illustrated as being carried out in a certain order, they could be carried out in a different order, or even simultaneously. If the state-of-charge difference ΔSOC does not exceed the difference threshold, or the output setpoint N_{c} is not greater than the minimum level N_{r,min}, subroutine S80 can be finalised without changing the output setpoint N_{c}. On the other hand, if the state-of-charge difference ΔSOC exceeds the difference threshold, and the output setpoint N_{c} is still greater than the upper threshold N_{r,max}, the output setpoint N_{c} may be decreased in a step S862, for example by assigning it the value of the lower threshold N_{r,min}, and the value of the flag F can be reset to zero in a step S863 in order to trigger a reference state of charge update SOCᵣ in the following cycle.

If in step S850 the current state of charge SOC_{c} has been found to be less than or equal to the first state-of-charge threshold SOC₁, subroutine S80 may proceed to step S870, in which the current state of charge SOC_{c} is compared to a second state-of-charge threshold SOC₂ less than the first state-of-charge threshold SOC₁. If the current state of charge SOC_{c} remains greater than or equal to this second state-of-charge threshold SOC₂, a step S871 of comparing the state-of-charge difference ΔSOC to a difference threshold may be performed, which may, in particular, be a second state-of-charge threshold ΔSOC_{c2}. If the state-of-charge difference ΔSOC does not reach this difference threshold, subroutine S80 can be finalised directly.

However, if the state-of-charge difference ΔSOC is greater than or equal to the difference threshold, the next step is to compare the output setpoint N_{c} with the intermediate level N_{r, int} in a step S872, and to assign the value of this intermediate level N_{r,int} to the output setpoint N_{c} in a subsequent step S874 after resetting to zero the value of flag F in an intermediate step S873 if the output setpoint N_{c} was still higher than the intermediate level N_{r,int} in step S872, and must therefore be reduced in step S874. Thus, an update of the reference state of charge SOCᵣ in the following cycle will be triggered as a result of this reduction. Finally, if the state-of-charge difference ΔSOC does not reach this difference threshold, it is still possible to compare the output setpoint N_{c} with the upper threshold N_{r,max} in a step S875. If this upper threshold N_{r,max} is reached, subroutine S80 can be finalised directly, but if this upper threshold N_{r,max} is not yet reached, it is possible to adopt its value as the output setpoint N_{c} in a step S876.

Although the present invention has been described by referring to specific exemplary embodiments, it is obvious that various modifications and changes can be made to these examples without going beyond the general scope of the invention as defined by the claims. In addition, the individual features of different embodiments mentioned can be combined in additional embodiments. Consequently, the description and the drawings should be considered as illustrating rather than limiting.

1. A method for controlling the output of an engine assembly of an aircraft, comprising at least the following steps:
updating an output setpoint of the engine assembly as a function of a current state of charge of an on-board energy storage device, and
controlling the engine assembly according to the output setpoint of the engine assembly.

2. The method according to claim 1, wherein updating the output setpoint comprises the following steps:
determining a state-of-charge difference of the on-board energy storage device which is a difference of the current state of charge of the on-board energy storage device with respect to a reference state of charge, and
comparing said state-of-charge difference with a difference threshold.

3. The method according to claim 2, wherein a maximum electrical power that can be extracted from the engine assembly at an output of the engine assembly according to the output setpoint is less than an electrical power required by the aircraft, said reference state of charge is a state of charge of the on-board energy storage device when the maximum electrical power that can be extracted from the engine assembly has become less than the electrical power required by the aircraft, and said difference threshold is a discharge threshold.

4. The method according to claim 3 wherein, during updating, the output setpoint is maintained at a previous level if said state-of-charge difference does not exceed the discharge threshold, electric assistance is required for the engine assembly, and/or an upper threshold of the output setpoint is reached, and the output setpoint is increased if said state-of-charge difference exceeds the discharge threshold, electrical assistance is not required for the engine assembly, and the upper threshold of the output setpoint is not reached.

5. The method according to claim 3, wherein a first value is assigned to the discharge threshold when the current state of charge is not less than an upper state-of-charge threshold, and a second value is assigned to the discharge threshold when the current state of charge is less than the upper state-of-charge threshold, but not less than a lower state-of-charge threshold.

6. The method according to claim 2, wherein a maximum electric power that can be extracted from the engine assembly at an output of the engine assembly according to the output setpoint is not less than an electric power required by the aircraft, said reference state of charge is a state of charge of the on-board energy storage device the maximum electrical power that can be extracted from the engine assembly has become greater than or equal to the electrical power required by the aircraft, or the engine output setpoint has been reduced, and said difference threshold is a charge threshold.

7. The method according to claim 6 wherein, during updating the output setpoint is maintained at a previous level if said state-of-charge difference does not exceed the charge threshold and/or if the output setpoint is at a lower threshold.

8. The method according to claim 6, wherein a first value is assigned to the charge threshold when the current state of charge is not less than an upper state-of-charge threshold, and a second value is assigned to the charge threshold when the current state of charge is less than the upper state-of-charge threshold, but not less than a lower state-of-charge threshold.

9. The method according to claim 1, wherein the output of the engine assembly remains an idling output less than a maximum nominal output of the engine assembly, in particular less than or equal to 70% of said maximum nominal output.

10. The control device suitable for implementing the method according to claim 2.

11. The computer program comprising instructions which cause the control device to perform the steps of the method of claim 1.

12. An The engine assembly for an aircraft comprising a control device according to claim 10, a combustion engine, and an electric machine configured to extract electrical power.

13. The aircraft engine assembly according to claim 12, wherein the electric machine is also configured to provide electrical assistance to the engine assembly.

14. The aircraft engine assembly according to claim 12, wherein the combustion engine is a gas turbine engine.

15. The aircraft comprising an engine assembly according to claim 12, as well as an on-board energy storage device electrically connected to said electric machine of the engine assembly.

16. The aircraft according to claim 15, wherein the on-board energy storage device is a rechargeable electric battery.
